(19) United States
(12) Patent Application Publication
(10) Pub. No.: US 2004/0102275 A1
(43) Pub. Date: May 27, 2004

(54) Axle assembly

(76) Inventors: Jyotsnamoy Chakraborty, Plymouth, MI (US); Norman Szalony, Brighton, MI (US)

Correspondence Address: Lorri W. Cooper, Jones, Day, Reavis & Pogue, North Point, 901 Lakeside Avenue, Cleveland, OH, 44114, US

(21) Appl. No.: 10/301,004

(22) Filed: Nov. 21, 2002

(51) Int. Cl. F16H 48/06

(52) U.S. Cl. 475/225

(57) ABSTRACT

An axle assembly for transmitting power between a drive shaft and driven wheels of a vehicle, with first and second half shafts being coupled to the driven wheels, comprises a driven gear set, a driving gear set, a pair of independently rotatable crown wheels, and a pre-axle differential gear set. The driven gear set has at least two driven gears and is associated with the drive shaft. The driving gear set has at least two driving gears. The pair of crown wheels are driven by the driving gears. The pre-axle differential is driven by the drive shaft and is configured to rotatably drive the driven and driving gear sets. The pre-axle differential is positioned between the driven gear set and the driving gear set. Another embodiment of the axle assembly utilizes a thrust bearing positioned between the pair of crown wheels.

### FIELD OF THE INVENTION

The claimed invention relates to an axle assembly. In particular, the claimed invention concerns a split torque axle assembly for use in a vehicle.

### BACKGROUND OF THE INVENTION

Motor vehicles use an axle assembly to drive the wheels of the vehicle. Many vehicles use a single crown wheel driven by a gear set that is coupled to the drive shaft. The drive shaft is connected to the engine and the transmission of the vehicle while the gear set is coupled to the wheels of the vehicle. Split torque axle assemblies have been designed to split the torque from the drive shaft in two parallel paths for driving a pair of crown wheels. By splitting the torque from the drive shaft into two separate paths to drive two crown wheels, the torque applied to the crown wheels is reduced. As a result, smaller crown wheels can be utilized for the same or greater torque. Smaller crown wheels are desirable because they provide greater clearance between the drive train of the vehicle and the ground, take up less room under the vehicle, and are generally lighter in weight, among other benefits.

Differential's are also known for use in axle assemblies. Differentials allow the wheels of a vehicle to spin at different speeds under certain circumstances, such as when the vehicle turns around corners. Limited slip differentials are a form of differential that transmits torque to a non-spinning wheel and limits the amount of torque that is applied to a spinning or slipping wheel.

### SUMMARY

According to one embodiment of the invention, an axle assembly is provided for transmitting power between a drive shaft and driven wheels of a vehicle, with first and second half-shafts being coupled to the driven wheels. The axle assembly comprises a driven gear set, a driving gear set, a pair of independently rotatable crown wheels, and a pre-axle differential gear set. The driven gear set has at least two driven gears and is associated with the drive shaft. The driving gear set has at least two driving gears. The pair of crown wheels are coupled together and each crown wheel is rotatably coupled to one of the driving gears of the driving gear set. The pre-axle differential is driven by the drive shaft and is configured to rotatably drive the driven and driving gear sets. The pre-axle differential is positioned between the driven gear set and the driving gear set. The drive shaft drives the differential gear set. The differential gear set drives the driven and driving gear sets, and the driving gear set drives the pair of crown wheels.

In another embodiment, an axle assembly is provided for transmitting power between a drive shaft and driven wheels of a vehicle, with first and second half shafts being coupled to the driven wheels. The axle assembly comprises a driven gear set, a driving gear set, a crown wheel gear set, a pre-axle differential, and a thrust bearing positioned between the crown wheel gear set. The driving gear set is operatively associated with the driven gear set. The crown wheel gear set is operatively associated with the driving gear set. The pre-axle differential gear set is driven by the drive shaft and is operatively associated with the driven and driving gear sets.

### BRIEF DESCRIPTION OF THE DRAWING FIGURES

FIG. 1 is a side perspective view of a first embodiment of the axle assembly of the invention;

FIG. 2 is a top perspective view of the axle assembly of FIG. 1;

FIG. 3 is a schematic top view of the axle assembly of FIG. 1;

FIG. 4 is a schematic top view of a second embodiment of the axle assembly;

FIG. 5 is a schematic top view of a third embodiment of the axle assembly;

FIG. 6 is a schematic top view of a fourth embodiment of the axle assembly;

FIG. 7 is a schematic top view of a fifth embodiment of the axle assembly; and

FIG. 8 is a schematic top view of a sixth embodiment of the axle assembly.

### DETAILED DESCRIPTION OF THE INVENTION

The present invention concerns a split torque axle assembly 10. Torque from a vehicle's drive shaft 12 is split between two parallel torque transmission paths 14, 16 to drive two separate crown wheels 18, 20, which rotate independently of one another. Each of the crown wheels 18, 20 is fixedly coupled to a half-shaft 22 and each half-shaft 22 is connected to one of the driven wheels 24 of a vehicle (not shown). An axle axis X-X is defined longitudinally along the length of the half-shafts 22 and a drive shaft axis Y-Y is defined longitudinally along the length of the drive shaft 12. The axle axis X-X is perpendicular to the drive shaft axis Y-Y.

By splitting the power from the drive shaft 12 between two parallel torque transmission paths 14, 16, the torque from the drive shaft 12 is split between the two crown wheels 18, 20. Because of the split in torque, the torque that is transmitted to the crown wheels 18, 20 is greatly reduced relative to prior designs that utilized a single crown wheel and a single torque transmission path. The size of the crown wheels 18, 20 and associated gear sets of the axle assembly 10 is determined by the maximum application of torque from the vehicle's engine. Since each torque transmission path 14, 16 of the current invention carries half the design torque, the gears of the axle assembly can be made smaller in size. As a result, the entire axle assembly 10 of the invention is smaller than current axle assemblies of equal torque capacity. Smaller gears are advantageous in that they generally produce less noise and vibration. They also weigh less than larger gears and take up less room under the vehicle chassis.

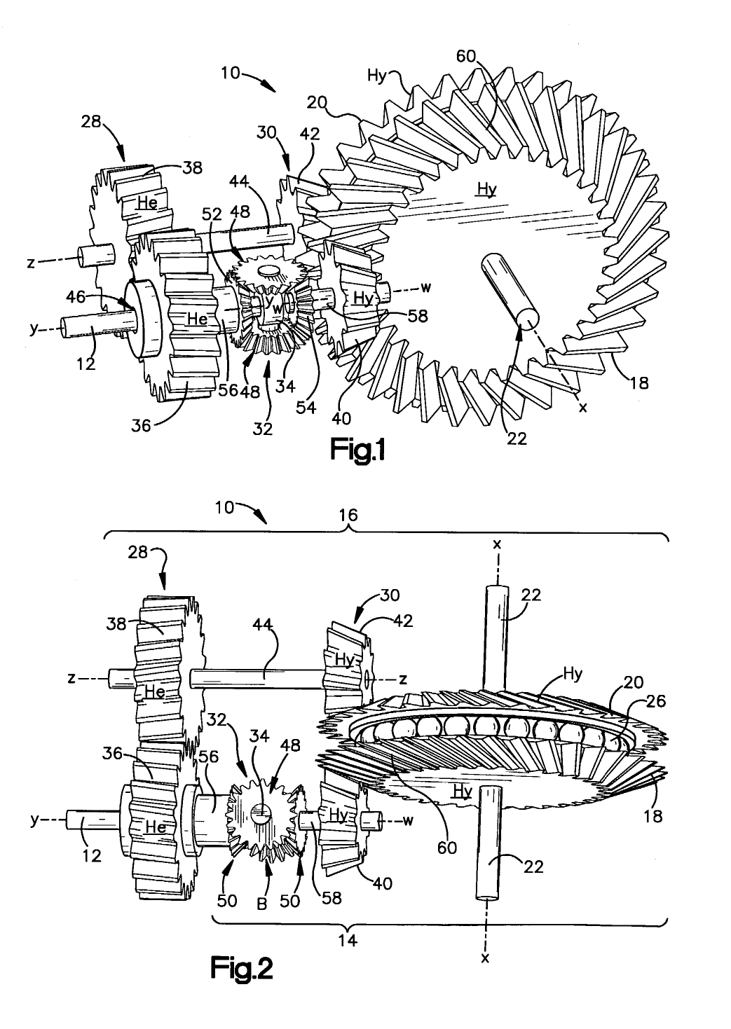

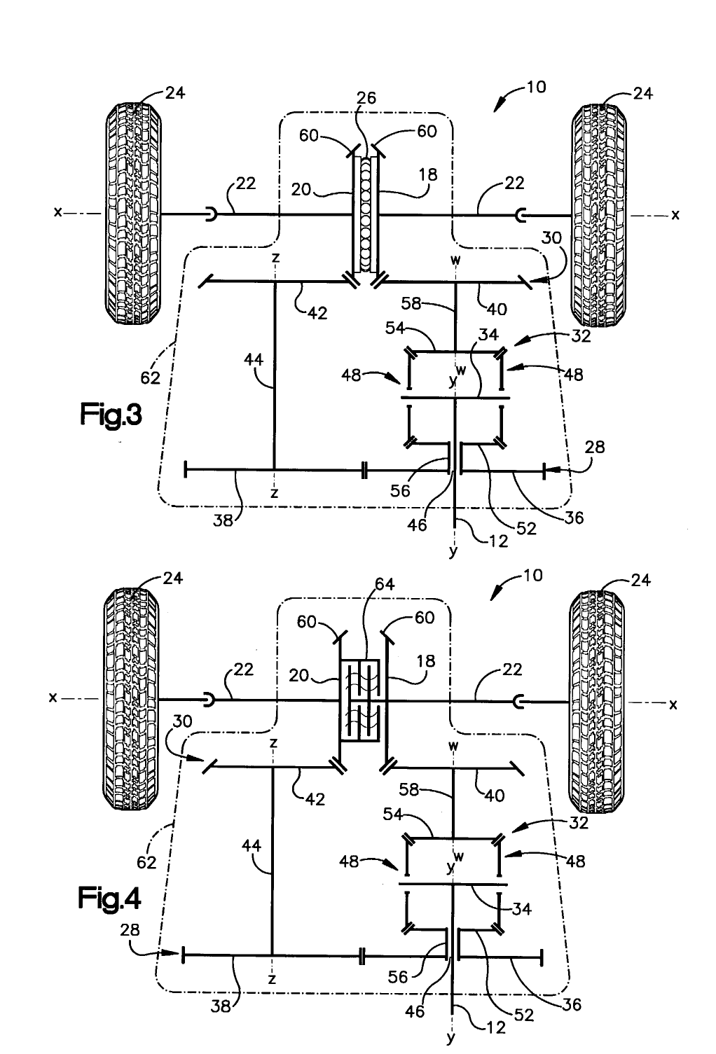

An axle assembly 10 will typically utilize bearings that are coupled to gears for rotation about several different shafts. With the exception of a thrust bearing, shown in FIGS. 2 and 3, FIGS. 1-8, for simplicity sake, depict the axle assemblies of the invention without bearings. A typical axle assembly will have bearings, so while the present drawings do not depict bearings, bearings are preferably included in the assembly, as known by those of skill in the art.

Referring to FIGS. 1-3, for a first embodiment of the invention, a crown wheel gear set, including a first crown wheel 18 and a second crown wheel 20, is positioned within the axle assembly 10 and is axially aligned along the axle axis X-X. Each of the crown wheels 18, 20 is independently rotatable relative to the other crown wheel. A thrust bearing 26 is positioned between the two crown wheels and serves as a bearing that allows rotation of the first crown wheel 18 relative to the second crown wheel 20. The thrust bearing 26 operates to neutralize any thrust that may be transmitted between the first and second crown wheels 18, 20.

The axle assembly 10 further includes a driven gear set 28, a driving gear set 30, and an open pre-axle differential 32. A pre-axle differential is one that is positioned prior to the axle axis X-X of the driven wheels 24, in contrast to a differential that is positioned in line with the axle axis. An open pre-axle differential is one that does not utilize a rotating differential casing. Instead, it utilizes a differential pin 34, also known as a spider. The differential pin rotates the differential gears, rather than the differential easing. The pre-axle differential operates in a conventional manner and is utilized to allow the wheels 24 of the vehicle to rotate at different speeds under certain circumstances, such as when the wheels 24 turn around corners. A differential pin 34 having two arms is shown in the drawings. However, a differential pin having more than two arms may also be utilized. For instance, a pin having three or more arms, with gears being associated with each arm, may also be utilized with the differential 32.

The driven gear set 28 is positioned longitudinally upstream of the driving gear set 30, and the pre-axle differential 32 is positioned between the driven gear set 28 and the driving gear set 30. The driven gear set 28 includes a first driven gear 36 and a second driven gear 38. The driving gear set 30 includes a third driving gear 40 and a fourth driving gear 42. The first driven gear 36, the pre-axle differential 32, and the third driving gear 40 are axially aligned with the drive shaft axis Y-Y. The second driven gear 38 and the fourth driving gear 42 are positioned on a first shaft 44 that is spaced from and parallel to the drive shaft axis Y-Y. The first shaft has a longitudinal axis Z-Z. The pre-axle differential 32, third driving gear 40 and the first crown wheel 18 together define the first torque transmission path 14. The pre-axle differential 32, first driven gear 36, second driven gear 38, fourth driving gear 42, and second crown wheel 20 together define the second torque transmission path 16.

The first and second driven gears 36, 38 are transversely aligned so that rotation of the first driven gear 36 causes rotation of the second driven gear 38. The driving gears 40, 42 are rotatably coupled to the crown wheels 18, 20 such that rotation of the third driving gear 40 drives the first crown wheel 18 and rotation of the fourth driving gear 42 drives the second crown wheel 20.

The first driven gear 36 includes an axially aligned central bore 46 and the drive shaft 12 extends through the bore 46. The drive shaft 12 is freely rotatable within the central bore 46, but constrained from lateral movement. The drive shaft 12 is connected to the differential pin 34 and rotates the differential pin in response to torque transmitted by the vehicle's engine. The differential pin 34 is coupled to a first differential gear set 48, which in turn is coupled to a second differential gear set 50. The first differential gear set 48 includes two gears, each of which are rotatably positioned at opposite ends of the differential pin 34. The second differential gear set 50 includes two differential gears that are rotatably coupled to the first differential gear set 48. One of the gears 52 in the second differential gear set is positioned upstream of the differential pin 34, e.g., closer to the first driven gear 36, and the other gear 54 in the second differential gear set 50 is positioned downstream of the differential pin 34, e.g., closer to the third driving gear 40. The upstream differential gear 52 is coupled to an upstream shaft 56, which is shaped like a bushing that encircles the drive shaft 12 and is fixed to the first driven gear 36. By using a bushing, the upstream shaft 56 is rotatable independently of the drive shaft 12. The downstream differential gear 54 is coupled to a downstream shaft 58 that is fixed to the third driving gear 40, such that both the downstream differential gear 54 and the third driving gear 40 rotate upon the downstream shaft 58. The downstream shaft has a longitudinal axis W-W.

In operation, the axle assembly 10 derives power from the drive shaft 12, which rotates the differential pin 34 and the first differential gear set 48. The first differential gear set 48 rotates the upstream and downstream differential gears 52, 54. For the first torque transmission path 14, the downstream differential gear 54 rotates the downstream shaft 58 and the associated third driving gear 40. The third driving gear 40, in turn, rotates the first crown wheel 18. For the second torque transmission path 16, the upstream differential gear 52 rotates the upstream shaft 56 which, in turn, rotates the first driven gear 36. The first driven gear 36 rotates the second driven gear 38, which rotates the first shaft 44 and the associated fourth driving gear 42. The fourth driving gear 42 then rotates the second crown wheel 20.

In the embodiment shown in FIGS. 1-3, the drive shaft axis Y-Y and the first shaft axis Z-Z are vertically aligned with one another and with the axle axis X-X. Other positionings of the drive shaft axis Y-Y and the first shaft axis Z-Z may also be utilized. For instance, the first shaft axis Z-Z and/or the drive shaft axis Y-Y can be offset from the axle axis X-X and from one another. The first shaft axis Z-Z may be vertically positioned above the axle axis X-X while the downstream shaft axis W-W is positioned below the axle axis X-X. In another embodiment, the first shaft axis Z-Z, downstream axis W-W, and the drive shaft axis X-X may be non-parallel.

Different types of gears may be utilized with the axle assembly 10. For example, the first and second driven gears 36, 38 may be spur gears S or helical HE gears (as shown). The third and fourth driving gears 40, 42 may be bevel B, hypoid HY (shown), or face gears. The first and second crown wheels 18, 20 may be bevel B, hypoid HY (shown), or face gears, and the differential gears may be straight bevel gears B, or other gears known to those of skill in the art.

As shown in FIGS. 1-3, the face 60 of each of the crown wheels faces outwardly, or opposite the opposing crown wheel. The gears of the driving gear set 30 mesh with the outward faces 60 of the crown wheel gears 18, 20 to rotatably drive the crown wheel gears. By having the crown wheel gears face outwardly so that the driving gears apply rotational force inwardly toward the crown wheels, the thrust bearing 26 positioned between the two crown wheels is put into compression. In contrast, if the crown wheel gears were to face in the same direction, the driving gears would put the thrust bearing in tension, which would then require a stronger thrust bearing than is necessary with the present design.

In addition, the assembly 10 is designed such that any axial thrust that is created is counterbalanced. As a result, there is less axial force applied within the assembly which results in less unbalanced forces within the axle housing. When helical gears HE are used for the driven gears 36, 38, axial thrust may be counterbalanced by optimizing the angle of the helical gears HE to reduce any axial thrust that is created. An optimized angle of the helical gears HE allows the helical gears HE to counterbalance opposite forces on the driving gear 42. By counterbalancing the axial forces within the axle assembly 10, no or minimal axial load is applied to the crown wheels 18, 20. As a result, the types of bearings that may be utilized within the system may be made simpler and lighter in weight.

All of the elements of the axle assembly, including the driven gear set 28, the driving gear set 30, the crown wheel gear set, and the pre-axle differential 32 are housed in a casing 62. The casing preferably includes a lubricant to promote efficient operation of the various gears within the casing 62. The casing 62 is stationary (non-rotating). The casing shape may be adjusted based upon the position of the various components within the axle assembly 10. For example, if interference is encountered under the vehicle's chassis by a non-related system, the shafts and gears of the assembly 10 may be moved in a forward or backward direction, or may be offset from the axle axis X-X both vertically and horizontally, in order to accommodate the interference. Thus, the present design provides flexibility in packaging.

Another embodiment of the invention is shown in schematic form in FIG. 4 and is similar to the embodiments shown in FIGS. 1-3. Instead of a thrust bearing 26 being positioned between the crown wheels as in FIGS. 1-3, the embodiment utilizes a multiple-plate clutch 64 positioned between the crown wheels 18, 20 in conjunction with a pre-axle differential. The multiple-plate clutch 64 is a type of in-line traction control that deters the driven wheels 24 from rotating at different speeds under normal operating conditions, but allows the wheels to rotate at different speeds when subjected to higher force loads. The multiple-plate clutch 64 hinders any speed differentiation between the crown wheels 18, 20 by generating frictional torque inside the device. The multiple-plate clutch 64 is utilized to prevent slippage of one driven wheel relative to the other.

The multiple-plate clutch 64 may be actively or passively controlled. The clutch may include, for example, a viscous or rheological fluid, a spring-loaded disc clutch, or similar types of clutches. In a passively controlled system, the user may activate the clutch by performing an operation within the vehicle, such as pushing a button. With active control (not shown), the clutch is electronically activated when a particular variable is sensed, such as a large variation between the speed of one crown wheel relative to the other. In the case of active control, an electronic control unit (ECU) 66 may be provided, as well as speed sensors 68 or other sensors, which are used to trigger the activation of the clutch 64.

Another embodiment of the invention is shown in schematic form in FIG. 5 and is similar to the embodiments shown in FIGS. 1-3. Instead of a pre-axle differential 32, the assembly utilizes a pre-axle limited-slip differential 70, as known by those of skill in the art. The limited-slip differential 70 is positioned at the same position within the assembly as the pre-axle differential 32, between the driven gear set 28 and the driving gear set 30, and is coupled to the drive shaft 12. The limited-slip differential 70 senses the difference in speed between the driven wheels 24 and limits the amount of slip that a particular wheel may encounter by transferring power from a slipping wheel to a non-slipping wheel. The limited slip effect on the driven wheels 24 is amplified due to the torque amplification by the axle ratio of the current design. Limited-slip differentials 70 have further benefits in that they work well with lower torque applications and are much easier to control than the multiple-plate clutch 64 of the prior embodiment.

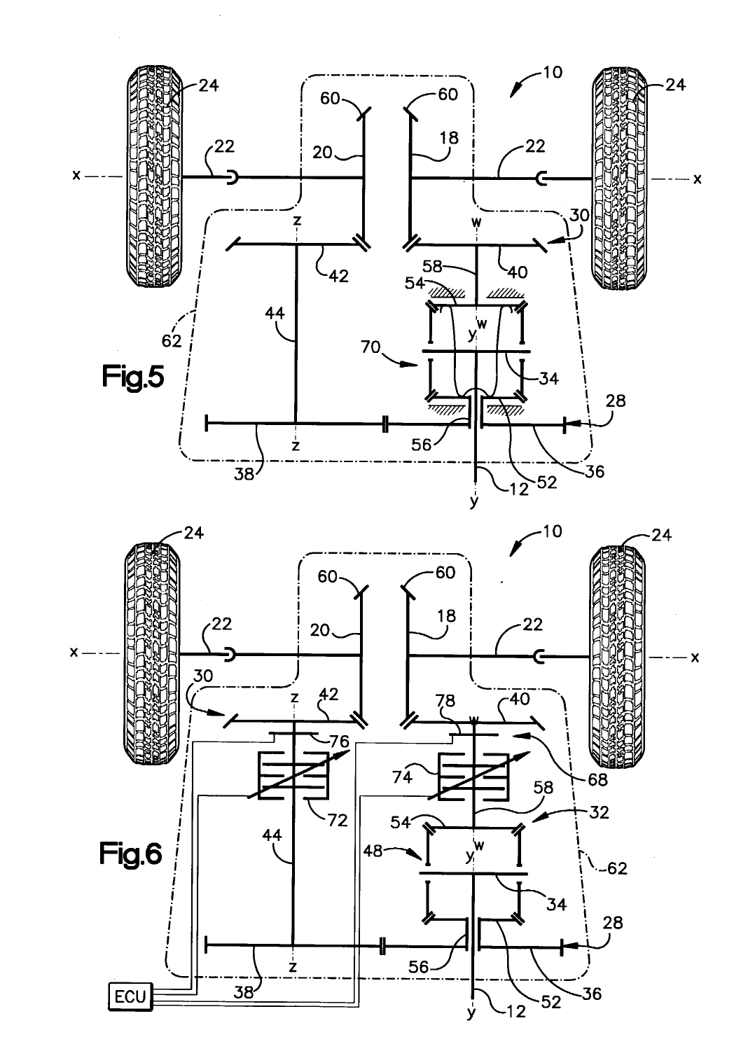

Yet another embodiment of the invention is shown in schematic form in FIG. 6 and is similar to the embodiments shown in FIGS. 1-3. In addition to the features discussed in FIGS. 1-3, the assembly includes speed sensors 68 and a brake-assist arrangement. In particular, a first brake-assist mechanism 72 is positioned on the downstream shaft 58 and a second brake assist mechanism 74 is positioned on the first shaft 44. Each brake-assist mechanism is independently functional. The brake-assist mechanisms 72, 74 are preferably actively controlled by an electronic control unit (ECU) 66. The assembly also includes a first speed sensor 76 that is positioned on the first shaft 44 and a second speed sensor 78 that is positioned on the downstream shaft 58. The speed sensors 76, 78 are shown positioned between the brake-assist mechanism 72, 74 and the corresponding driving gear 40, 42. However, speed sensors 76, 78 may be positioned at any location along the corresponding shafts, the invention not being limited to a particular placement of the speed sensors 76, 78.

The brake-assist arrangement utilized with this embodiment is particularly useful with lower torque, higher speed applications. In a conventional braking arrangement, the brakes of the vehicle apply directly to the driven wheels 24 of the vehicle. In the present arrangement, a brake-assist mechanism 72, 74 is utilized to assist the conventional brakes by slowing the vehicle by applying a braking function along the torque transmission paths 14, 16, as well as to the driven wheels 24 of the vehicle. The brake-assist mechanisms 72, 74 help to decrease the speed of the corresponding shaft at the same time that the conventional brakes are applied to the driven wheels 24. This saves wear and tear on the conventional brakes. The speed sensors 76, 78 help to sense the speed of the individual shafts in order to determine how much braking to apply to the shafts. The entire braking operation may be controlled by the ECU 66 without the knowledge of the vehicle's driver. The whole system may function in conjunction with the vehicle's ABS system, as known by those of skill in the art.

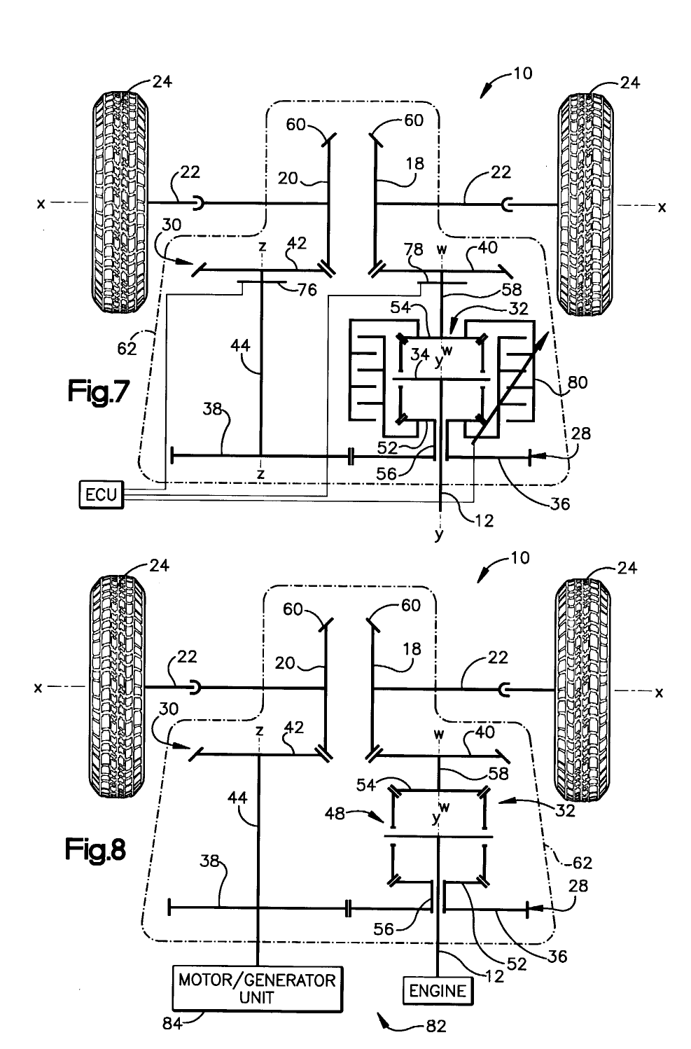

Another embodiment of the invention is shown in schematic form in FIG. 7 as utilizing an arrangement similar to that shown in FIGS. 1-3, but with traction control incorporated with the open pre-axle differential 32. The traction control includes a multi-plate clutch 80, which may include a viscous or rheological fluid, a spring-loaded disc clutch, or a similar type clutch. The multi-plate clutch 80 functions as a braking mechanism and serves to limit the output from the differential 32. The assembly also includes speed sensors 76, 78 that are positioned on the first shaft 44 and the downstream shaft 58, respectively, for sensing the speed of the shafts. The multi-plate clutch 80 and speed sensors 76, 78 are electronically coupled to an electronic control unit (ECU) 66. The ECU 66 provides active control because it is not necessary for the user to initiate any instructions in order for the assembly to function. The speed sensors 76, 78 are utilized to sense the speed of the shafts, and the ECU 66, upon obtaining the speed readings from the sensors, determines when and whether to apply the braking function to the differential 32 based upon programming provided in the ECU 66. This embodiment may alternatively utilize passive control where the user is required to initiate instructions in order to operate the clutch system, such as pressing a button, among other initiation techniques.

A further embodiment of the invention is shown in schematic form in FIG. 8 and incorporates a parallel hybrid drive-line arrangement 82 that utilizes both an engine and a motor/generator unit 84, as known by those of skill in the art. The embodiment shown in FIG. 8 is similar to that of FIGS. 1-3. In this embodiment, an alternative power source 84, such as a motor/generator or fuel cell/battery, is positioned in series with one of the torque transmission paths 14, 16. The hybrid drive line arrangement 82 may incorporate provisions such as power regeneration and power source selectivity choices, among other provisions.

The hybrid arrangement 82 disclosed in FIG. 8 is advantageous over prior designs since the parallel hybrid drive element 84 has direct access to the drive shaft 12. In prior designs, it was necessary to use an epicyclic gear box in order for the hybrid design to gain access to the drive shaft. Advantageously, each of the above-described embodiments may be utilized with a hybrid drive-line arrangement.

It should be noted that while the first driven gear 36 is driven by the differential 32, it also performs a driving function. In particular, the first driven gear 36 drives the second driven gear 38. The various name of the gears utilized herein should not be used strictly to determine the function of the gears, since the gears may have functions other than or in addition to those described by their names. While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. An axle assembly for transmitting power between a drive shaft and driven wheels of a vehicle, with first and second half shafts being coupled to the driven wheels, said axle assembly comprising:
a driven gear set having at least two driven gears and being associated with the drive shaft;
a driving gear set having at least two driving gears;
a pair of independently rotatable crown wheels coupled together, with each crown wheel being rotatably coupled to one of the driving gears in the driving gear set; and
a pre-axle differential gear set driven by the drive shaft, said differential gear set being configured to rotatably drive the driven and driving gear sets, and said pre-axle differential being positioned between the driven gear set and the driving gear set, wherein the drive shaft drives the differential gear set, the differential gear set drives the driven and driving gear sets, and the driving gear set drives the pair of crown wheels.

2. The axle assembly of claim 1, further comprising a thrust bearing coupled between the pair of crown wheels.

3. The axle assembly of claim 1, further comprising a casing surrounding the driven gear set, the driving gear set, the differential gear set, and the pair of crown wheels.

4. The axle assembly of claim 1, wherein the driven gear set comprises a first driven gear and a second driven gear, the driving gear set comprises a third driving gear and a fourth driving gear, the drive shaft extends through an opening in the first driven gear, and further comprising an upstream shaft attached to the differential gear set for rotating the first driven gear and a downstream shaft attached to the differential gear set for rotating the third driving gear.

5. The axle assembly of claim 4, wherein the upstream shaft is a bushing that extends around the drive shaft.

6. The axle assembly of claim 4, further comprising a first shaft coupled between the second driven gear and the fourth driving gear, wherein the second driven gear drives the fourth driving gear through rotation of the first shaft.

7. The axle assembly of claim 1, wherein the differential gear set includes a first gear set, a second gear set, and a differential pin, with the differential pin being coupled to the first gear set and the first gear set being rotatably coupled to the second gear set, with the second gear set including an upstream gear and a downstream gear, wherein the upstream differential gear is rotatably coupled to the first driven gear and the downstream differential gear is rotatably coupled to the third driving gear.

8. The axle assembly of claim 1, wherein the pre-axle differential is an open pre-axle differential, a limited slip differential, or a multi-plate clutch differential.

9. The axle assembly of claim 1, wherein the pair of crown wheels are coupled together by a clutch.

10. The axle assembly of claim 9, wherein the clutch is a multiple plate clutch.

11. The axle assembly of claim 9, further comprising an electronic control unit for electronically controlling the clutch.

12. The axle assembly of claim 1, further comprising at least one speed sensor positioned adjacent the driving gear set, at least one brake-assist mechanism positioned adjacent the at least one speed sensor, and an electronic control unit electronically coupled to the at least one speed sensor and the at least one brake-assist mechanism, said electronic control unit for controlling the operation of the at least one brake-assist mechanism in response to input from the at least one speed sensor.

13. The axle assembly of claim 4, further comprising a first speed sensor coupled to the first shaft and a second speed sensor coupled to the downstream shaft, wherein the first and second speed sensors are configured to sense the speed of rotation of their corresponding shafts.

14. The axle assembly of claim 13, further comprising a first brake-assist mechanism coupled to the first shaft, a second brake-assist mechanism coupled to the downstream shaft, and an electronic control unit electronically coupled to the first speed sensor, the second speed sensor, the first brake-assist mechanism, and the second brake-assist mechanism, said electronic control unit for controlling the first brake-assist mechanism and the second brake-assist mechanism in response to input from the first and second speed sensors.

15. The axle assembly of claim 13, further comprising a clutch coupled to the pre-axle differential and an electronic control unit electrically coupled to the first and second speed sensors and the clutch, wherein the electronic control unit, in response to inputs from the first and second speed sensors, is configured to communicate with the clutch to provide traction control to the axle assembly.

16. The axle assembly of claim 1, wherein the drive shaft is coupled to the engine and further comprising a generator unit coupled to an auxiliary drive shaft, said auxiliary drive shaft being coupled to the driven gear set, wherein both the engine and the generator unit are operative to drive the axle assembly.

17. An axle assembly for transmitting power between a drive shaft and driven wheels of a vehicle, with first and second half shafts being coupled to the driven wheels, said axle assembly comprising:
a driven gear set;
a driving gear set operatively associated with the driven gear set;
a crown wheel gear set operatively associated with the driving gear set;
a pre-axle differential gear set operatively associated with the drive shaft and the driven and driving gear sets; and
a thrust bearing positioned between the crown wheel gear set.

18. The axle assembly of claim 17, wherein the pre-axle differential is positioned between the driven and driving gear set.

19. The axle assembly of claim 17, wherein the pre-axle differential gear set is coupled to and driven by the drive shaft.
